(19) United States
(12) Patent Application Publication
(10) Pub. No.: US 2003/0088494 A1
(43) Pub. Date: May 8, 2003

(54) Business method and system for expediting request for quotation (RFQ) processes in a network environment

(76) Inventor: Juhnyoung Lee, Yorktown Heights, NY (US)

Correspondence Address: McGuire Woods, LLP, Suite 1800, 1750 Tysons Boulevard, McLean, VA, 22102-3915, US

(21) Appl. No.: 09/733,035

(22) Filed: Dec. 11, 2000

(51) Int. Cl. G06F 17/60

(52) U.S. Cl. 705/37; 705/26

(57) ABSTRACT

An improved system and method for market makers of electronic marketplaces provides RFQ processes over a network in a way that shortens the time taken to run an RFQ process without sacrificing effectiveness as a trading mechanism. At the same time, buyers are allowed to research the market without actually submitting RFQs to the electronic marketplace. In this way, the accuracy the market research and the effectiveness of trading is increased by aggregating tentative and historical sell bids from multiple electronic marketplaces.

### BACKGROUND OF THE INVENTION

1. Field of the Invention

This invention relates to online trading over a computer network. More specifically, the invention relates to online trading over the Internet where buyers and sellers make one or more trading deals on one or more products that have two or more attributes by using an RFQ (Request For Quotation) process in one or more electronic marketplaces. Further, the invention relates to the use of one or more tentative and/or historical sell bids for helping buyers research the market without actually posting his/her RFQs and shorten the RFQ process by removing the RFQ posting step. In addition, the invention relates to the aggregation of tentative and/or historical sell bids from one or more electronic marketplaces and the use of the aggregated sell bids for buyers using RFQs.

2. Background Description

Commerce over networks, particularly electronic commerce (e-commerce) over the Internet, has increased significantly over the past few years. Part of e-commerce enables buyers and sellers to make trades in one or more Web sites. Those Web sites are often referred to as electronic marketplaces (e-marketplace), and provide one or more different forms of trading mechanisms including auction, reverse auction, and exchange. In an auction, one seller receives bids from one or more buyers for one or more products before making a transaction, while in a reverse auction, one buyer receives bids from one or more potential sellers. In an exchange, multiple buyers and multiple sellers submit bids and asks, respectively, to a marketplace which makes matches between the asks and bids either continuously or periodically.

Each of these trading mechanisms can have several variations depending on the specific rules applied to the mechanism. Variations of auctions include English (buyers call ascending prices), Dutch (market manager calls descending prices to obtain buy bids), Japanese (market manager calls ascending prices to obtain buy bids), and sealed bid (buyers place sealed bids). Auctions further include open Request For Bids (buyers call ascending prices and seller manually selects winners) and sealed Request For Bids (buyers submit sealed bids and seller manually selects winners). Variations of reverse auctions include reverse English (sellers call descending prices), reverse Dutch (market manager calls ascending prices to obtain sell bids), reverse Japanese (market manager calls descending prices to obtain sell bids), and reverse sealed bid (sellers place sealed bids). Reverse auctions further include open Request For Quotes (sellers call descending prices and buyer manually selects winners) and sealed Request For Quotes (sellers submit sealed bids and buyer manually selects winners). Variations of exchanges include continuously clearing exchanges and periodically clearing exchange.

As described, the Request for Quotation (RFQ) is a type of reverse auction where a request is submitted by a buyer to an electronic marketplace to invite potential sellers to bid on specific products or services needed by the buyer's company or public agency. The RFQ process is useful in all markets that depend upon multiple attributes more than just price, the RFQ process allows buyers to communicate with one or more sellers who make sell bids for requesting more information about products and/or negotiating deals. Also, the RFQ process allows buyers to manually select one or more bids from sellers after examining and comparing submitted sell bids. The RFQ process allows for sellers to produce exactly what buyers want, leading to strong rate of return due to high satisfaction ratings. To support this flexibility in trading, the RFQ process usually comprises several steps: (1) RFQ creation (by a buyer), (2) RFQ submission (by the buyer to an e-marketplace), (3) RFQ posting (in the e-marketplace), (4) sell bid submission (by one or more sellers to the e-marketplace), (5) sell bid evaluation (by the buyer), (6) negotiation (between the buyer and one or more sellers), and (7) purchase.

One problem with the prior art is that the RFQ process, despite its advantages over other forms of auction, usually takes longer time to complete a trading deal than others, due to the set of sequential steps to needs to be followed. Especially, the steps of RFQ posting, sell bid evaluation, and negotiation are time-consuming, for example, each of the steps can take several days, and sometimes, weeks.

Another problem with the prior art is that the RFQ process requires a buyer who submit an RFQ to go over the time-consuming steps of RFQ, when he/she modifies the RFQ (for example, some constraints on product attribute values) for receiving a different set of sell bids (with either higher or lower cardinality). When a buyer submits an RFQ, he or she may not have sufficient information about the market and provide unreasonable values for the RFQ attributes. The result may be unreasonably high or low number of sell bids, which makes the RFQ process ineffective. The prior art does not provide any means to test the market without submitting an actual RFQ and following the time-consuming steps.

### SUMMARY OF THE INVENTION

It is therefore an object of this invention is an improved system and method for market makers of electronic marketplaces to provide RFQ processes over a network.

Another object of this invention is to provide an improved system and method for market makers of electronic marketplaces to provide RFQ processes over a network that shortens the time taken to run an RFQ process without sacrificing effectiveness as a trading mechanism.

A further object of this invention is to provide an improved system and method for market makers of electronic marketplaces to provide RFQ processes over a network that shortens the time taken to run an RFQ process without sacrificing effectiveness as a trading mechanism, and at the same time allowing buyers to research the market without actually submitting RFQs to the electronic marketplace.

A more specific object of the present invention is to provide an improved system and method for market makers of electronic marketplaces to provide RFQ processes over a network that shortens the time taken to run an RFQ process without sacrificing its effectiveness as a trading mechanism, at the same time allowing buyers to research the market without actually submitting RFQs to the electronic marketplace, and increasing the accuracy the market research and the effectiveness of trading by aggregating tentative and historical sell bids from multiple electronic marketplaces.

According to one aspect of the invention, there is provided a computer system for one or more buyers and one or more sellers to trade one or more products and/or services by using one or more RFQ processes over one or more computer networks. An RFQ creation process enables one or more buyers to create one or more RFQs with one or more attribute values of preference and one or more business conditions of preference. An RFQ submission process enables one or more buyers to submit one or more RFQs with one or more attribute values of preference and one or more business conditions of preference to one or more electronic marketplaces. An RFQ receiving process enables one or more electronic marketplaces to receive one or more RFQs submitted by one or more buyers. An RFQ storage process enables one or more electronic marketplaces to store one or more RFQs received from one or more buyers and to invite one or more sell bids from one or more potential sellers of one or more products and/or services specified in the RFQs. A sell bid creation process enables one or more sellers to create one or more sell bids with one or more attribute values. A sell bid submission process enables one or more sellers to submit one or more sell bids with one or more attribute values to one or more electronic marketplaces. A sell bid receiving process enables one or more electronic marketplaces to receive one or more sell bids submitted by one or more sellers on one or more RFQs posted on the electronic marketplaces. A sell bid storage process enables one or more electronic marketplaces to store one or more sell bids submitted by one or more sellers in one or more database systems. A multi-attribute matching process enables one or more electronic marketplaces to match between one or more RFQs and one or more sell bids stored in one or more database systems. A sell bid presentation process enables one or more electronic marketplaces to present one or more sell bids that satisfy the attribute values of preference and business conditions of preferences of one or more RFQs to the buyers who submitted the RFQs to one or more electronic marketplaces. A sell bid process enables one or more buyers to view and evaluate one or more sell bids that satisfy the attribute value of preference and business conditions of preference of one or more RFQs and select one or more sell bids as winning bids. A communication process enables one or more buyers and sellers to communicate with one another to provide more information about one or more RFQs and one or more sell bids and further negotiate on one or more deals. A transaction completion process enables one or more buyers who select one or more sell bids as winning bids to purchase one or more products and/or services specified in the sell bids.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a known system architecture;

FIG. 2 is a flow diagram of a known RFQ process;

FIG. 3 is a block diagram of a preferred system architecture with tentative and historical sell bids;

FIG. 4 is a flow diagram of a preferred business process with tentative and historical sell bids;

FIG. 5 is a block diagram of a preferred system architecture with sell bid aggregation;

FIG. 6 is a flow diagram of a preferred business process with sell bid aggregation;

FIG. 7 is a diagram of an example of an RFQ known in the prior art;

FIG. 8 is a diagram of an example of a submitted sell bid record according to the present invention;

FIG. 9 is a diagram of an example of a tentative sell bid record according to the present invention; and

FIG. 10 is a diagram of an example of a historical sell bid record according to the present invention.

### DETAILED DESCRIPTION OF A PREFERRED EMBODIMENT OF THE INVENTION

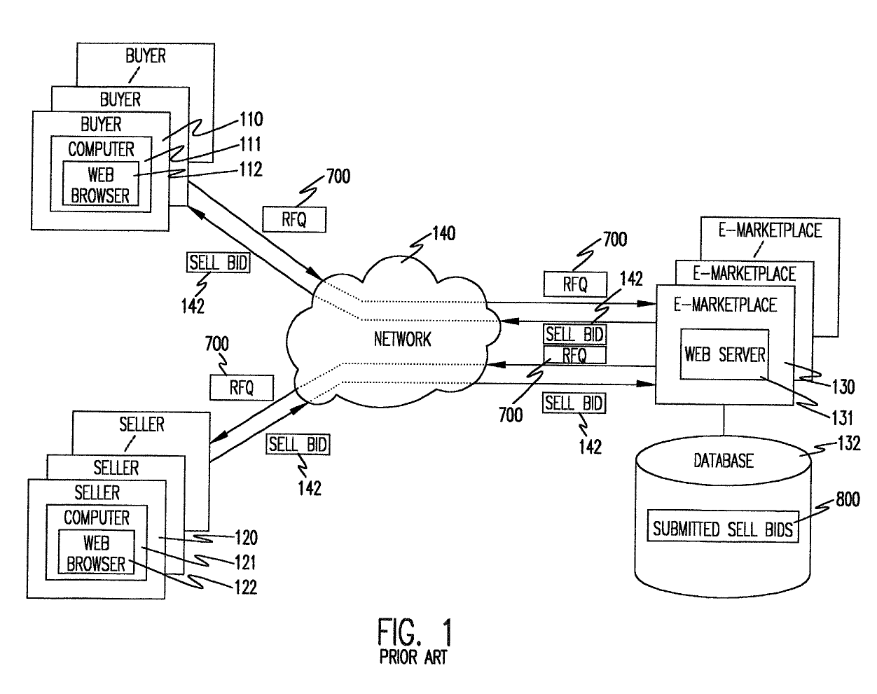

Referring now to the drawings, and more particularly to FIG. 1, there is shown a block diagram of one preferred system architecture in the prior art showing one or more buyers 110, one or more computers 111 used by the buyers 110, one or more Web browser programs 112 used by the buyers 110, one or more sellers 120, one or more computers 121 used by the sellers 120, one or more Web browser programs 122 used by the buyers 120, one or more e-marketplaces 130, one or more Web server systems 131 of the e-marketplaces 130, one or more database systems 132 of the e-marketplaces 130, one or more submitted sell bid records 800 stored in the database system 132, a computer network 140, one or more RFQs 700 submitted to the e-marketplaces 130 by one or more buyers 110, and one or more sell bids 142 submitted to the e-marketplaces 130 by one or more sellers 120.

An e-marketplace 130 is preferably implemented with a Web server system 131 and stores data about trading including product catalogs, information about buyers and sellers, and information about various markets, in particular, information about sell bids submitted by sellers, in a database system 132. This invention specifically relates to the RFQ process among various trading mechanisms in electronic marketplaces. In an RFQ process, a buyer 110 submits an RFQ 700 to an e-marketplace 130 by using his or her Web browser program 112 running on his or her computer 111. The Web server system 131 of the e-marketplace 130 receives the RFQ 700 and post it as a new market in the e-marketplace 130. One or more sellers 120 who finds the posted RFQ interesting submit one or more sell bids 142 to the e-marketplace 130 by using his/her Web browser program 122 running on his/her computer 121. The buyer 110 who make the RFQ 700 selects winners among the submitted sell bids 142. For communication, Web browser programs 112 and 122 of sellers and buyers and Web server system 131 of the e-marketplace 130 typically use HTTP (HyperText Transfer Protocol) which is a network protocol defined for that purpose.

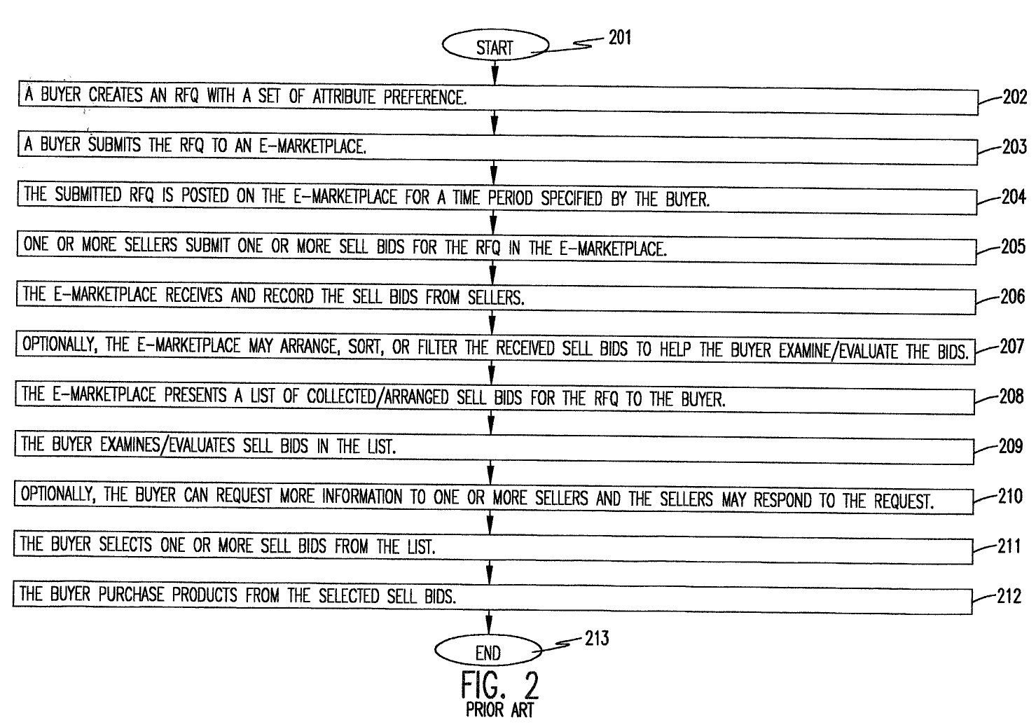

FIG. 2 is a flow chart of one preferred RFQ process showing the steps in the prior art. As the first step 202, a buyer 110 creates an RFQ 700 for one or more products or services with a set of attribute preference. The attribute preference include product attributes and other relevant factors including price, quantity, material quality, product quality ratings, merchant reputation, warranty, support, delivery time, and delivery cost. The attribute preference will be used later for evaluating sell bids by the buyer 110. In addition, the buyer is allowed to specify a criterion for the termination of the RFQ, typically in a form of time and date of termination. To help buyers specify all this information about an RFQ and also to automate the matching among RFQs and sell bids, the e-marketplace 130 may provide a structured form (in one or more Web pages) for all the data entries described above.

Once an RFQ is created, the buyer 110 submits the RFQ to an e-marketplace 203. Receiving an RFQ, the e-marketplace 130 first stores the submitted information about the RFQ 700 in the database system 132 of the e-marketplace 130. Then, as the next step 204, it posts the submitted RFQ 700 on its Web site 131 for a time period specified by the buyer 110 and invites bids from sellers 120 on the particular products or services specified in the RFQ 700. The attribute preference of the RFQ 700 may or may not be revealed to potential sellers in the e-marketplace 130 depending on market type. In some cases, only portion of the attribute preference is posted while the rest is not.

As the next step 205, one or more sellers 120 respond to the RFQ by submitting sell bids to the e-marketplace 130. The sellers 120 also specify various relevant factors in their bids including price, quantity, volume discount policy, material quality, product quality ratings, merchant reputation, warranty, support, delivery time, and delivery cost. Again, to help sellers specify properties of their bids and also to aut9mate the matching among RFQs and submitted sell bids, the e-marketplace 130 may provide a structured form (in one or more Web pages) for data entries. As the next step 206, the e-marketplace 130 stores the information about the submitted sell bids 142 in the submitted sell bid records 800 in the database system 132 of the e-marketplace 130.

When the RFQ 700 is closed by the criterion specified by the buyer 110, the e-marketplace 130 retrieves the RFQ and sell bids 800 from the database system 132 and examines them, either manually or by using one or more computer tools. The e-marketplace 130 may allow the buyer 110 to examine this raw data and to select winning sell bids among the submitted or, optionally, poll 207 the e-marketplace 130 processes the submitted sell bids 800 before presenting them to the buyer 110. For example, the e-marketplace 130 may filter out sell bids that do not meet any one or more of the attribute preference specified by the buyer 110. Also, the e-marketplace 130 may rank and sort the sell bids by score that is calculated by using one, or more scoring algorithms.

As the next step 208, the fist of the submitted sell bids 800 is presented to the buyer 110. In most cases, the buyer 110 comes back to the e-marketplace 130 and finds the list of the submitted sell bids 800 posted in a specially determined place in the e-marketplace Web site 130. The buyer 110 examines the sell bids 800 in the list and evaluate them to select ones that meet the buyer's need best 209. Optionally, in step 210, the buyer 110 can request more information about one or more of the submitted sell bids 800 in the list. To help this information request process, the e-marketplace 130 may provide one or more hyperlinks for individual bids to Web pages that provide more information about the bid. The buyer 110 only needs to click on the hyperlinks to find more information about the bid. In addition, the buyer 110 may request more information which is not readily available in an electronic form such as Web pages. In this case, the e-marketplace 130 may provide contact information including phone number, facsimile number, and/or email address of sellers in the sell bid fist. Furthermore, once the buyer 110 is connected to a seller 120 through a method suggested by the e-marketplace 130, the buyer 110 and seller 120 can further negotiate about their bid in an effort to reach an agreement.

After finishing the evaluation of the submitted sell bids 800, the buyer 110 selects one or more sell bids from the given fist as winners 211. In some cases, it is possible that the buyer 110 does not select any bid as a winner. The buyer 110 will be able to submit a new RFQ with a modified set of attribute preferences and modified market rules. However, this invention considers such a case a separate RFQ, and does not include the resubmission of a modified RFQ in the preferred business process 200.

Finally, in step 212, the buyer 110 purchases products or services from the selected sell bids. Typically, the sell bid fist given by the e-marketplace 130 provides a buy button for each bid in the list. To complete a transaction for a selected sell bid, the buyer 110 simply clicks on the buy button of the sell bid. It allows the buyer to provide necessary payment information for completing a transaction. In some cases, the buy button is connected with a shopping cart capability, so that the buyer 110 needs to provide the payment information only once for payment of two or more selected bids. If the buy button capability is not available in the e-marketplace 130, the buyer 110 may need to resolve the issues of payment and product shipping directly with the seller 120.

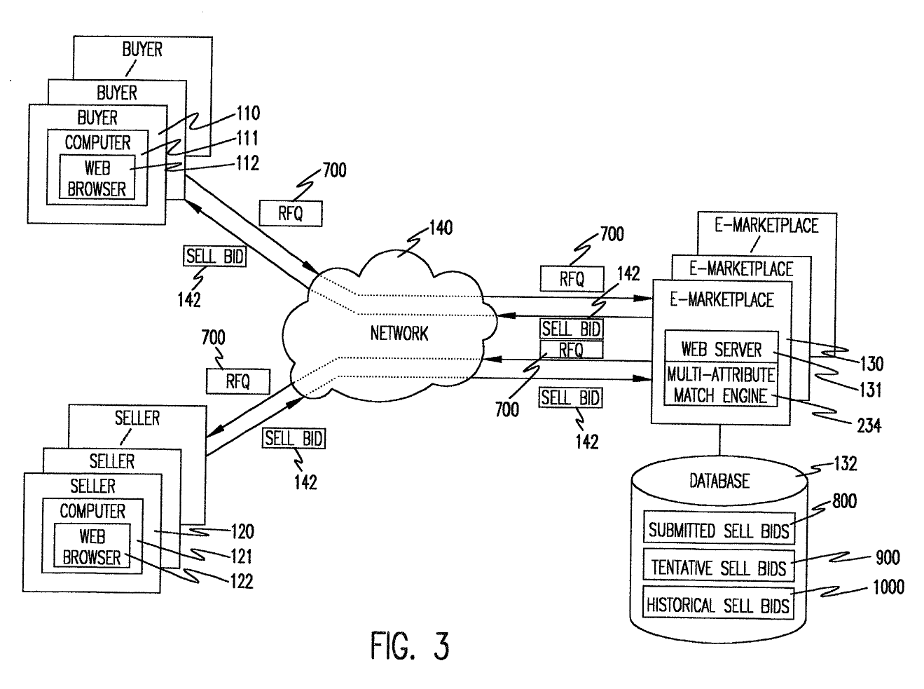

FIG. 3 is a block diagram of one preferred system architecture with tentative and historical sell bids showing the same set of objects shown in the block diagram of one preferred system architecture in the prior art 100, i.e., one or more buyers 110, one or more computers 111 used by the buyers 110, one or more Web browser programs 112 used by the buyers 110, one or more sellers 120, one or more computers 121 used by the sellers 120, one or more Web browser programs 122 used by the buyers 120, one or more e-marketplaces 130, one or more Web server systems 131 of the e-marketplaces 130, one or more database systems 132 of the e-marketplaces 130, one or more submitted sell bid records 800 stored in the database system 132, a computer network 140, one or more RFQs 700 submitted to the e-marketplaces 130 by one or more buyers 110, and one or more sell bids 142 submitted to the e-marketplaces 130 by one or more sellers 120.

In addition to these objects, this figure shows three more types of objects: a multi-attribute match engine 234, one or more tentative sell bid records 900 and one or more historical sell bid records 1000. Tentative and historical sell bid records are stored in the database 132 of an e-marketplace 130. To achieve its two primary objectives, i.e., giving RFQ buyers 110 opportunities to shorten the time taken to run an RFQ process and research the market without actually submitting an RFQ to the electronic marketplace, this invention uses two types of sell bids, i.e., tentative and historical sell bids that are different from submitted sell bids 800.

The submitted sell bids 800 are ones that are submitted by potential sellers 120 who view and respond to RFQs 700 posted on an e-marketplace 110. In contrast, the tentative sell bids 900 are ones that are submitted by potential sellers 120 for an information purpose without actually viewing RFQs. Tentative sell bids 130 are submitted by sellers 120 a priori, collected and stored in the database 132, and used as a catalog of potential sell bids by buyers 110 in an e-marketplace 130. A tentative sell bid can give an idea on what conditions the bid can satisfy. An assumption is that the content of a tentative sell bid is not guaranteed, and so that the buyer and seller need to confirm the content of the bid before making any decision. If a buyer 110 finds a suitable tentative sell bid 900 in the database 132, i.e., tentative bid catalog and its content confirmed by the seller 120 is not far off from what is recorded, then the buyer 110 can complete the RFQ process quickly, because he/she does not have to post the RFQ and wait for sell bids submitted. In case he/she submits the RFQ 700 to the e-marketplace 130 anyway, the buyer 110 can do that with better understanding to the market, thanks to the information from tentative sell bids 900.

The historical sell bids 1000 are yet another type of sell bids that are submitted by sellers 120 in response to previous RFQs, but not to the current RFQ. Historical sell bids 1000 are collected and stored in the database system 132 of the e-marketplace 130, and used as potential sell bids for one or more similar RFQs. Frequently, RFQs have similar constraints and preferences, especially in business environment. A historical sell bid can give an idea on what conditions the bid can satisfy. As with tentative sell bids, an assumption is that the content of a historical sell bid is not guaranteed, and so that the buyer and seller need to confirm the content of the bid before making any decision. If a buyer 110 finds a suitable historical sell bid 1000 in the database 132, i.e., historical bid catalog and its content is confirmed valid by the seller 120, then the buyer 110 can complete the RFQ process quickly, because he/she does not have to post the RFQ and wait for sell bids submitted. In case he/she submits the RFQ 700 to the e-marketplace 130 anyway, the buyer 110 can do that with better understanding to the market, thanks to the information from historical sell bids 1000.

Finally, the multi-attribute match engine 234 is a computer program running on top of the Web server system 131 of an e-marketplace 130 to find one or more matches between an RFQ and tentative sell bids 900 and/or between an RFQ and historical sell bids stored in the database 132. It examines attribute values of the RFQ and those of tentative/historical sell bids stored in the database 132 and locates all the tentative/historical sell bids that satisfy the attribute preference specified in the RFQ 700. In the business process of the prior art 200, a function of the e-marketplace 130 which is somewhat similar to that of the multi-attribute match engine 234 was described in filtering out one or more submitted sell bids which do not meet the attribute preference of the submitted RFQ 700. However, in the prior art business process shown in FIG. 2, the function was described as an option. The preferred business process of this invention requires a multi-attribute match engine 234 to make use of tentative and historical sell bids in RFQ processes.

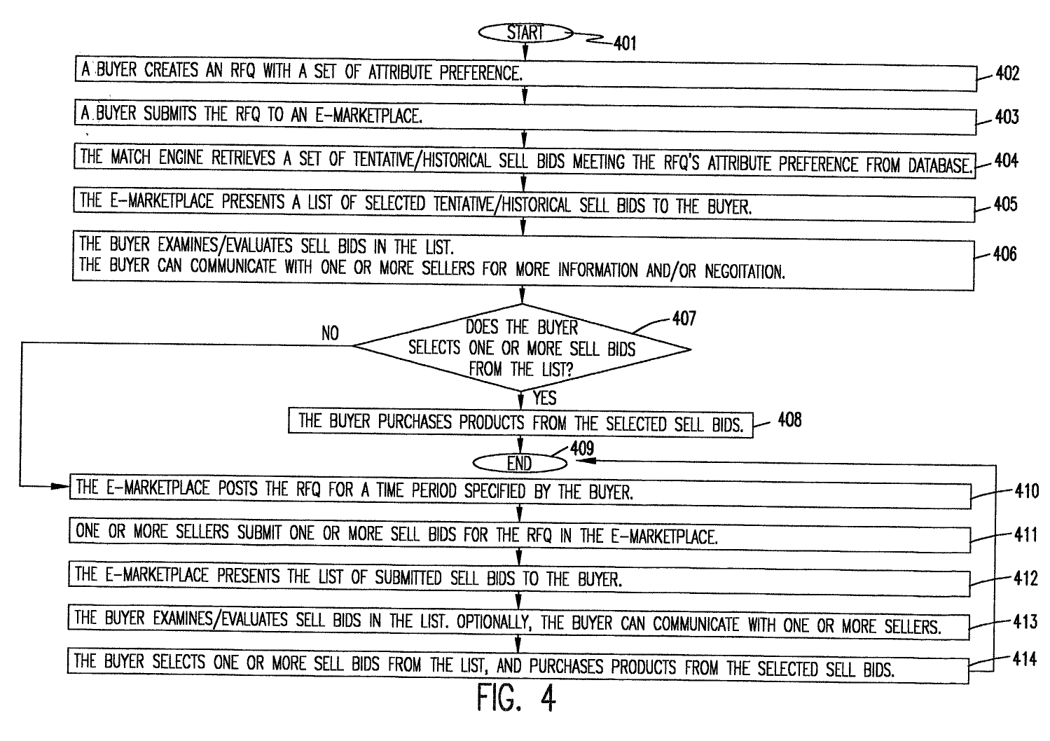

FIG. 4 is a flow chart of one preferred business process with tentative and historical sell bids. The first two steps of this process, i.e., an RFQ creation step 402 and an RFQ submission to an e-marketplace step 403 are the same as those of the prior art process shown in FIG. 2. However, before posting the submitted RFQ 700 to potential sellers 120, as the next step 404, the e-marketplace 130 compares the RFQ and its attribute preferences against the catalog of tentative historical sell bids 900 and 1000 stored in the database 132 by using the multi-attribute match engine 234. As a result of this database query 405, the match engine 134 of the e-marketplace 130 presents to the buyer 110 a fist of tentative historical sell bids 900 and 1000 that meet attribute preferences of the submitted RFQ 700.

As the next step 406, the buyer 110 will examines and evaluates the located tentative historical sell bids, and also communicate with one or more sellers 120 of the located sell bids to confirm the validity of the bids and further negotiate on the bids. If the buyer selects one or more sell bids among the located tentative historical sell bids in step 407, then in step 408 the buyer purchases one or more products from the selected sell bids and the RFQ process completes at this point. Note that in this case, the buyer could achieve his goal more quickly than with prior art, because he/she does not post the RFQ in the e-marketplace and wait for sell bids submitted by sellers.

If the buyer does not find any interesting sell bids from the catalog of tentative historical sell bids or the buyer wants to review more sell bids, then in step 410 the e-marketplace 130 will posts the RFQ 700 and invites more sell bids from sellers 120. If this happens, the following steps 411, 412, 413, and 414 remain the same as in the prior art shown in FIG. 2.

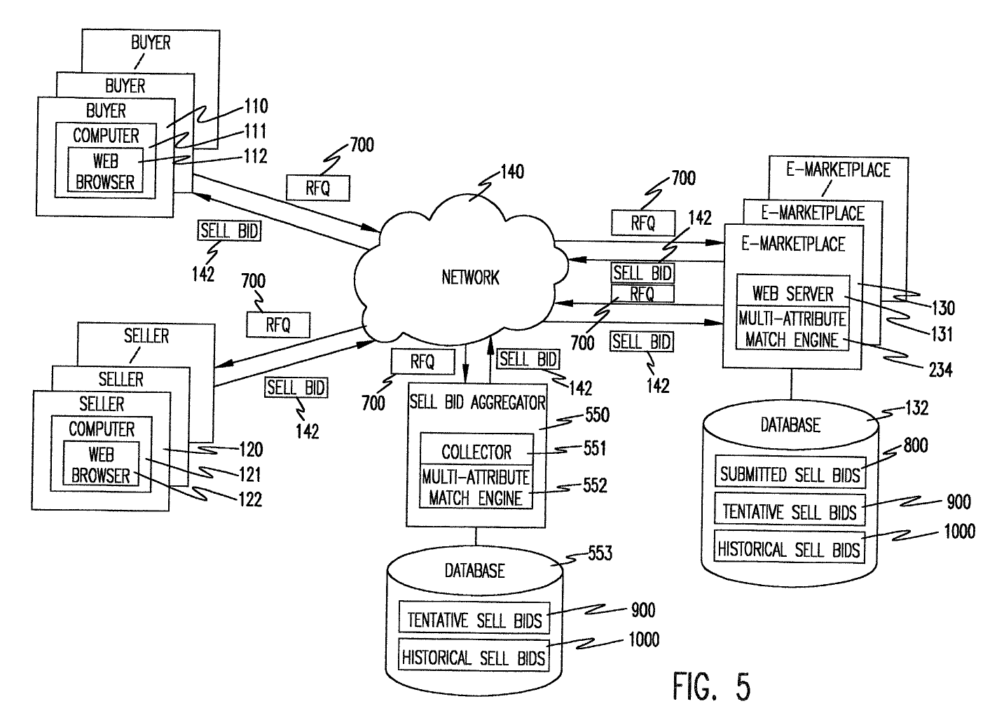

FIG. 5 is a block diagram of one preferred system architecture with sell bid aggregation showing the same set of objects shown in the block diagram of one preferred system architecture with tentative and historical sell bids 300, i.e., one or more buyers 110, one or more computers 111 used by the buyers 110, one or more Web browser programs 112 used by the buyers 110, one or more sellers 120, one or more computers 121 used by the sellers 120, one or more Web browser programs 122 used by the buyers 120, one or more e-marketplaces 130, one or more Web server systems 131 of the e-marketplaces 130, one or more multi-attribute match engine 234, one or more database systems 132 of the e-marketplaces 130, one or more submitted sell bid records 800 stored in the database system 132, one or more tentative sell bid records 900 stored in the database system 132, one or more historical sell bid records 1000 stored in the database system 132, a computer network 140, one or more RFQs 700 submitted to the e-marketplaces 130 by one or more buyers 110, and one or more sell bids 142 submitted to the e-marketplaces 130 by one or more sellers 120.

In addition to these objects, this figure shows one or more sell bid aggregator systems 550 which comprises one or more collector processes 551, one or more multi-attribute match engine processes 552, one or more database systems 553, one or more tentative sell bid records 900 stored in the database system 553, one or more historical sell bid records 900 stored in the database system 553. One potential problem with the system and method of using tentative and historical sell bids for RFQ processes in an e-marketplace is that, if the size of the bid catalog of tentative/historical sell bids stored in the database system 132 of an e-marketplace 130 is small, the match engine 234 cannot find a sufficient set of tentative and historical bids. If this situation happens, the usefulness of keeping tentative/historical sell bids in database is diminished.

One method for overcoming this potential problem is to creating a large and rich set of tentative and historical sell bids by aggregating sell bids from two or more e-marketplaces 130 in the network. By having an agreement with those e-marketplaces and/or by using a Web site crawler technology that enables to automatically collect information from Web sites, the collector process 551 can gather information on tentative and historical sell bids from two or more e-marketplaces 130 and aggregate them in a structured form in tentative sell bid records 900 and historical sell bid records 1000 in the database system 553. The multi-attribute match engine 552 of the sell bid aggregator system 550 functions in the same way as that 234 of an e-marketplace 130, i.e., it finds matches between an RFQ and tentative historical sell bids stored in the database 553 by comparing their attribute values.

Note that a sell bid aggregation system 550 is preferably implemented by using a Web server system. Thus, the collector process 551 and multi-attribute match engine process 552 can be computer programs running on top of a Web server system. Also, buyers 110 and sellers 120 communicates with the sell bid aggregation system 550 by using HTTP (HyperText Transfer Protocol).

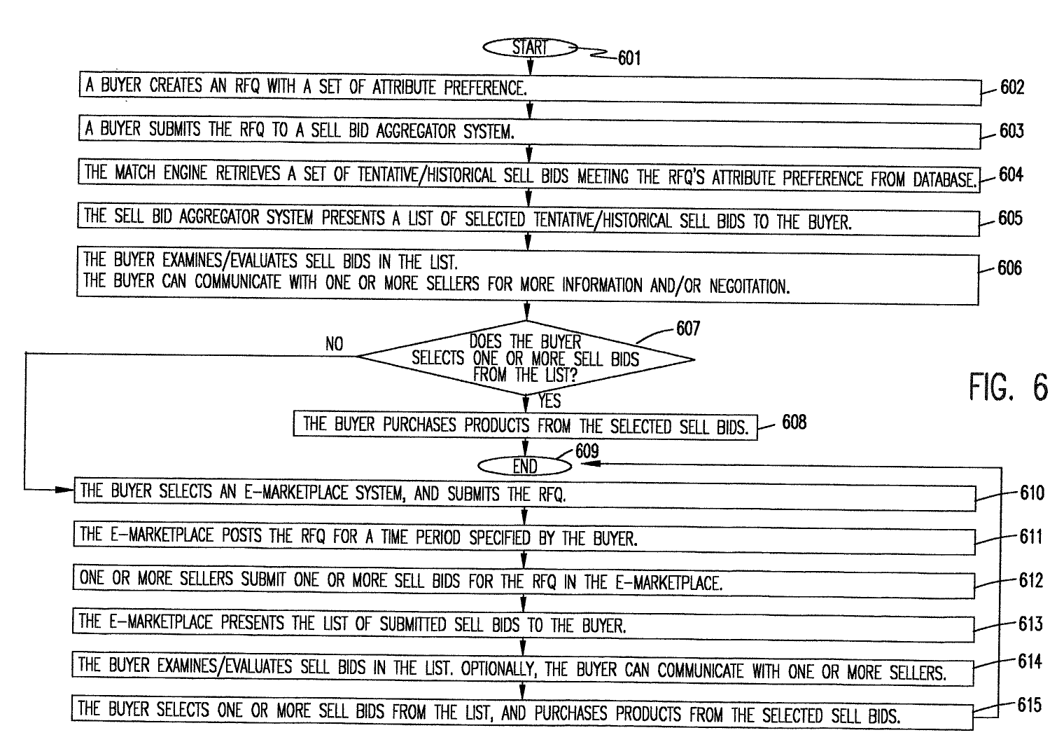

FIG. 6 is a flow chart of one preferred business process with sell bid aggregation. As in the previous business processes shown in FIGS. 2 and 4, the first step an RFQ creation 602. Then in step 603, the buyer submits the RFQ to a sell bid aggregator system 550 instead of an e-marketplace 130. As the next step 604, the sell bid aggregator system 550 compares the RFQ 700 and its attribute preferences against the bid catalog of tentative/historical sell bids 900 and 1000 stored in the database 553 by using the multi-attribute match engine 552. As a result of this database query in step 605, the match engine 552 of the sell bid aggregator system 550 presents to the buyer 110 a list of tentativet1historical sell bids 900 and 1000 that meet attribute preferences of the submitted RFQ 700.

As the next step 606, the buyer 110 examines and evaluates the located tentative historical sell bids and also communicates with one or more sellers 120 of the located sell bids to confirm the validity of the bids and further negotiate on the bids. If the buyer selects one or more sell bids among the located tentative historical sell bids in step 607, then in step 608 the buyer purchases one or more products from the selected sell bids and the RFQ process completes at this point. Note that in this case, the buyer 110 could achieve his goal more quickly than with prior art, because he or she does not post the RFQ in an e-marketplace and wait for sell bids submitted by sellers 120.

If the buyer 110 does not find any interesting sell bids from the bid catalog of tentative/historical sell bids in the sell bid aggregator system 550 or the buyer 110 wants to review more sell bids, the buyer has two options: trying out another sell bid aggregator system 550 and posting the RFQ in an e-marketplace 130. In the former case, the process will be basically the same as what is described in steps 602, 603, 604, 605, 606, 607, and 608 with only the content of tentative and historical sell bid records 900 and 1000 possibly being different. In the latter case, first 610 the buyer needs to select an e-marketplace 130 to submit his or her RFQ 700. Then 611 the e-marketplace 130 will posts the RFQ 700 and invites more sell bids from sellers 120. If this happens, the following steps 612, 613, 614, and 614 remain the same as in the prior art process shown in FIG. 2.

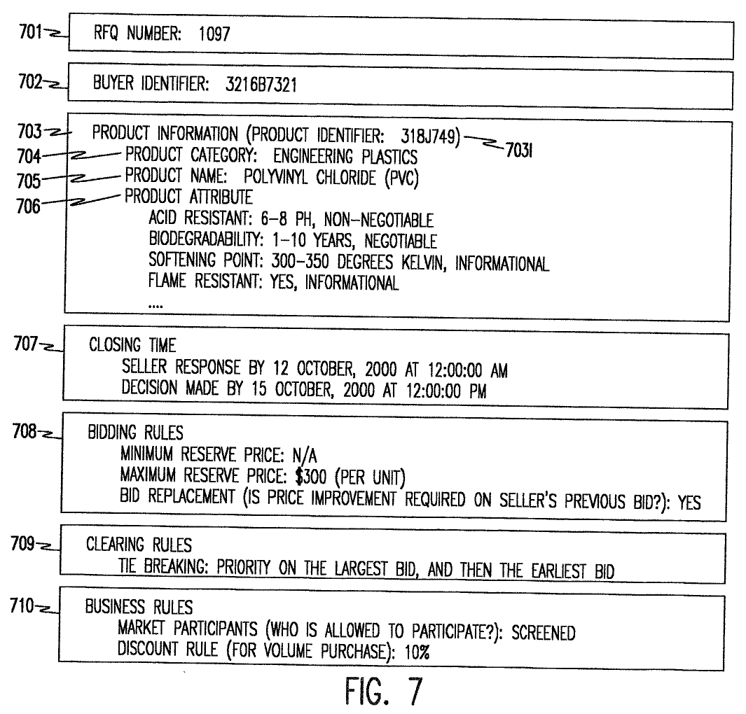

FIG. 7 is an example of an RFQ 700 in the prior art showing a RFQ number 701, a buyer identifier 702, a product information section 703 containing a product identifier 7031, one or more product category entries 704, one or more product name entries 705, and one or more product attribute sections 706, a closing time section 707, a bidding rule section 708, a clearing rule section 709, and a business rule section 710. Attribute preferences described in the business processes shown in FIGS. 2, 4 and 6 comprises the sections of product information 702, closing time 707, bidding rules 708, clearing rules 709, and business rules 710.

The RFQ number 701 identifies this RFQ in this e-marketplace 130. The buyer identifier 702 identifies the buyer who makes this RFQ. Product attributes 706 give preferred values for various product properties. Also, the product attribute values are categorized as negotiable, non-negotiable, or informational according to the strictness of the value requirement. The closing time section 707 specifies two points in time: until when the e-marketplace 130 receives sell bids from sellers 120 for this RFQ, and when the buyer 110 makes a decision about winning bids and present the result in the e-marketplace 130, The bidding rule section 708 specifies various rules applied to bidding. Examples include the minimum reserve price, maximum reserve price, and a rule for replacing a bid. The clearing rule section 709 specifies various rules applied to clearing of considered sell bids. An example is a rule for breaking ties of two or more sell bids with the same attributes. The business rule section 710 specifies various rules regarding business practice of the buyer 110. An example is the scope of market participants, i.e., who is allowed to participate in this RFQ—private, public, or screened?

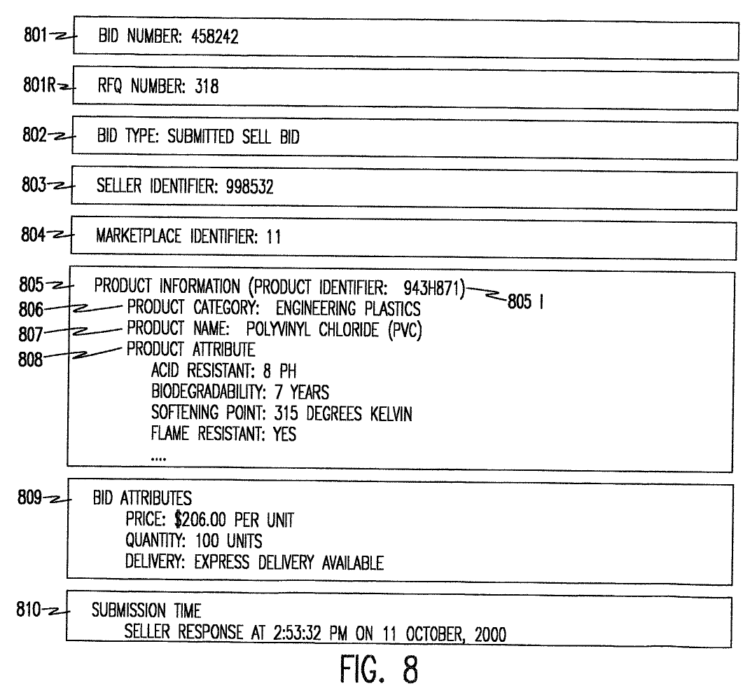

FIG. 8 is an example of a submitted sell bid record showing a bid number 801, a RFQ number 801R, a bid type section 802, a seller identifier 803, a marketplace identifier 804, a product information section 805 containing a product identifier 8051, one or more product category entries 806, one or more product name entries 807, and one or more product attribute sections 808, a bid attribute section 809, and a submission time section 810. The bid number 801 identifies this bid in this e-marketplace 130. The RFQ number 801R identifies the RFQ that this bid is submitted to. The bid type section 802 specifies the type of the bid, i.e., a submitted sell bid. The seller identifier 803 identifies the seller who makes this bid. The marketplace identifier 804 identifies the marketplace where this bid was made. The product information section 805 specifies various information about the product that this seller is bidding to the current RFQ, including the product identifier 8051, product category 806, product name 807, and product attribute values 808. The attribute values given in a bid are supposed to meet the conditions given for those attributes in the RFQ 700. The bid attribute section 809 specifies various properties of this bid including price, quantity, material quality, product quality ratings, merchant reputation, warranty, support, delivery time, and delivery cost. Finally, the submission time 810 specifies when this bid was submitted to the e-marketplace.

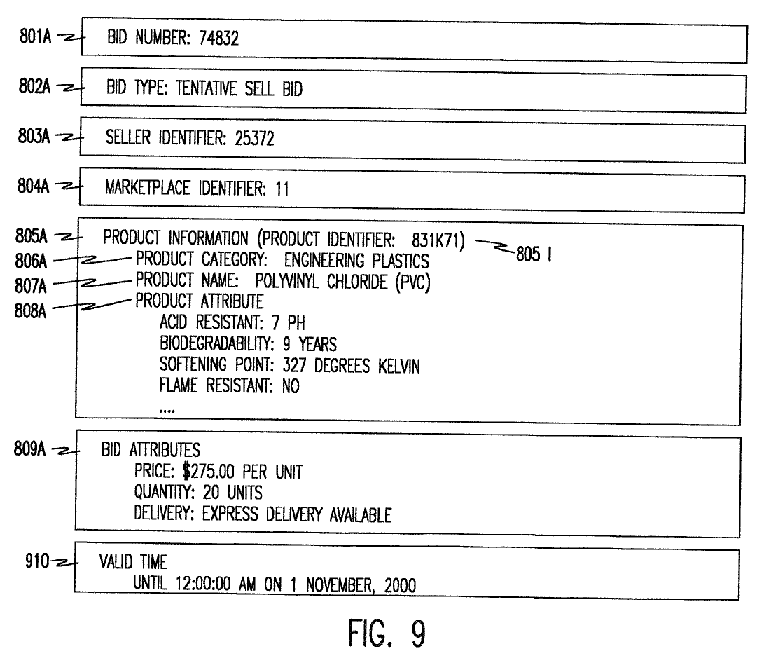

FIG. 9 is an example of a tentative sell bid record showing a bid number 801A, a bid type section 802A, a seller identifier 803A, a marketplace identifier 804A, a product information section 805A containing a product identifier 8051, one or more product category entries 806A, one or more product name entries 807A, and one or more product attribute sections 808A, and a bid attribute section 809A. Note that this record is specified as a tentative sell bid in the bid type section 802A and that this record does not have a target RFQ number 801R. Also note that, unlike a submitted sell bid record, a tentative sell bid record 900 does not have a submission time section 810A, because the bid is not actually submitted for an particular RFQ. Instead, a tentative sell bid record 900 has a valid time entry 910 which specifies until when this tentative sell bid is valid. This value is given by the seller 120.

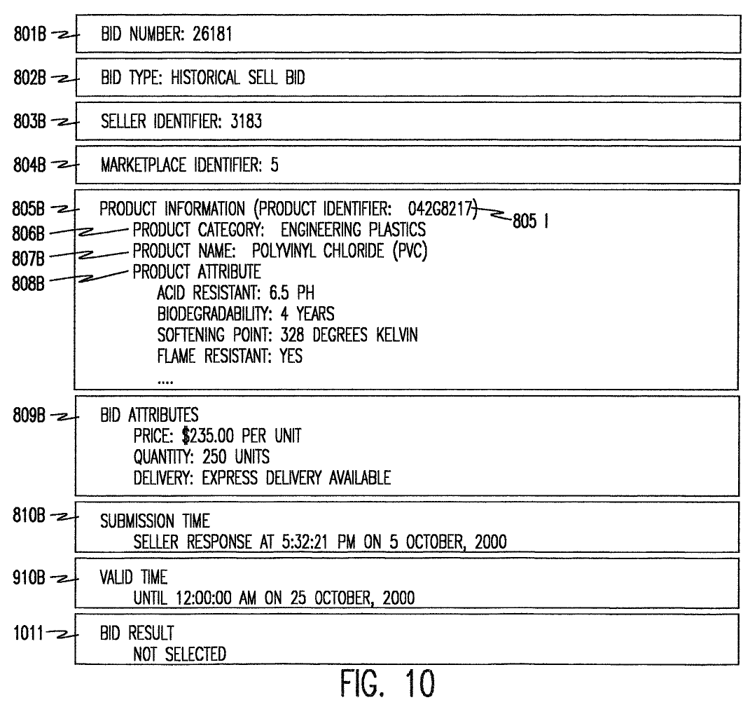

FIG. 10 is an example of a historical sell bid record showing a bid number 801B, a bid type section 802B, a seller identifier 803B, a marketplace identifier 804B, a product information section 805B containing a product identifier 8051, one or more product category entries 806B, one or more product name entries 807B, and one or more product attribute sections 808B, a bid attribute section 809B, a submission time section 810B, a valid time section 910B, and a bid result section 1011. Note that this record is specified as a historical sell bid in the bid type section 802B. Also note that, unlike a submitted and tentative sell bid, this record has both a submission time section 810B and a valid time section 910B. In addition, this record has a bid result section 1011 which specifies if this sell bid has been selected as a winning bid or not. Finally, it is important to note that this record does not reveal any information about the buyer who made an RFQ which this sell bid was originally submitted to for a security reason.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer system for one or more buyers and one or more sellers to trade one or more products and/or services by using one or more RFQ (Request for Quotation) processes over one or more computer networks, the system comprising:
one or more central processing units (CPUs), one or more memories, and one or more network interfaces to one or more networks;
an RFQ creation process that enables one or more buyers to create one or more RFQs with one or more attribute values of preference and one or more business conditions of preference;
an RFQ submission process that enables one or more buyers to submit one or more RFQs with one or more attribute values of preference and one or more business conditions of preference to one or more electronic marketplaces;
an RFQ receiving process that enables one or more electronic marketplaces to receive one or more RFQs submitted by one or more buyers;
an RFQ storage process that enables one or more electronic marketplaces to store one or more RFQs submitted by one or more buyers in one or more database systems;
an RFQ posting process that enables one or more electronic marketplaces to post one or more RFQs received from one or more buyers and to invite one or more sell bids from one or more potential sellers of one or more products and/or services specified in the RFQs;
a sell bid creation process that enables one or more sellers to create one or more sell bids with one or more attribute values;
a sell bid submission process that enables one or more sellers to submit one or more sell bids with one or more attribute values to one or more electronic marketplaces;
a sell bid receiving process that enables one or more electronic marketplaces to receive one or more sell bids submitted by one or more sellers on one or more RFQs posted on the electronic marketplaces;
a sell bid storage process that enables one or more electronic marketplaces to store one or more sell bids submitted by one or more sellers in one or more database systems;
a multi-attribute matching process that enables one or more electronic marketplaces to match between one or more RFQs and one or more sell bids stored in one or more database systems;
a sell bid presentation process that enables one or more electronic marketplaces to present one or more sell bids that satisfy the attribute values of preference and business conditions of preference of one or more RFQs to the buyers who submitted the RFQs to one or more electronic marketplace;
a sell bid evaluation process that enables one or more buyers to view and evaluate one or more sell bids that satisfy the attribute value of preference and business conditions of preference of one or more RFQs and select one or more sell bids as wining bids;
a communication process that enables one or more buyers and sellers to communicate with one another to provide more information about one or more RFQs and one or more sell bids and further to negotiate on one or more deals; and
a transaction completion process that enables one or more buyers who select one or more sell bids as winning bids to purchase one or more products and/or services specified in the sell bids.

2. A system, as in claim 1, where the RFQ comprises an RFQ identifier, a buyer identifier, a product/service identifier, one or more product/service category names, one or more product/service names, one or more product/service attribute values of preference, one or more product/service attribute importance indicators, a sell bid submission deadline, a sell bid evaluation deadline, one or more bidding rules, one or more sell bid clearing rules, and one or more business conditions of preference.

3. A system, as in claim 2, where the product/service attribute importance indicator comprises any one of two or more levels that indicate the degree of importance of a particular attribute value in a particular RFQ.

4. A system, as in claim 1, where the electronic marketplace is a Web site that allows one or more buyers and one or more sellers to make one or more trades of one or more products and/or services by using one or more trading mechanisms including the RFQ process.

5. A system, as in claim 1, where the sell bid is any one of the followings: submitted sell bid, tentative sell bid, and historical sell bid.

6. A system, as in claim 5, where the submitted sell bid comprises a bid identifier, a bid type, a target bid identifier, a seller identifier, a electronic marketplace identifier, a product/service identifier, one or more product/service category names, one or more product/service names, one or more product/service attribute values, one or more bid attributes, and a submission time.

7. A system, as in claim 6, where the product/service attribute values includes one or more values of price, quantity, material quality, product quality ratings, merchant reputation, warranty, support, delivery time, and delivery cost.

8. A system, as in claim 5, where the tentative sell bid comprises a bid identifier, a bid type, a seller identifier, a electronic marketplace identifier, a product/service identifier, one or more product/service category names, one or more product/service names, one or more product/service attribute values, one or more bid attributes, and a valid time.

9. A system, as in claim 5, where the historical sell bid comprises a bid identifier, a bid type, a seller identifier, a electronic marketplace identifier, a product/service identifier, one or more attribute values, one or more bid attributes, a submission time, a valid time, and a bid result.

10. A system, as in claim 1, where the sell bids are selected from two or more electronic marketplaces, and then aggregated and stored in one or more databases.

11. A system, as in claim 10, where the sell bid aggregation system stores one or more sell bids collected from two or more electronic marketplaces.

12. A method of doing business over a network comprising the steps of:
providing a buyer with one or more RFQ creation processes for creating one or more RFQs with one or more attribute values of preference and one or more business conditions of preference;
providing a buyer with one or more RFQ submission processes for submitting one or more RFQs to one or more sell bid aggregation systems which find one or more sell bids that satisfy the attribute values of preference and the business conditions of preference of the submitted RFQs;
providing a buyer with one or more communication processes for communicating with one or more sellers of the sell bids found by one or more sell bid aggregation systems to confirm the validity of the bids, find more information on the bids, and/or negotiate on the bids;
providing a buyer with one or more sell bid evaluation processes for evaluating one or more sell bids found by one or more sell bid aggregation systems, and selecting one or more sell bids among them as winning bids;
providing a buyer with one or more transaction completion processes for completing one or more purchases of one or more products/services given in one or more winning bids;
providing a buyer with one or more electronic marketplace selection processes for selecting one or more electronic marketplaces to submit one or more RFQs and receive more sell bids from one or more sellers;
providing a buyer with sell bid receiving processes for receiving one or more sell bids from one or more sellers by using one or more electronic marketplaces;
providing a buyer with one or more communication processes for communicating with one or more sellers who submit one or more sell to find more information on the bids, and/or negotiate on the bids;
providing a buyer with one or more sell bid evaluation processes for evaluating one or more sell bids submitted by one or more sellers, and selecting one or more sell bids among them as winning bids; and
providing a buyer with one or more transaction completion processes for completing one or more purchases of one or more products/services given in one or more winning bids.
